(19) United States
(12) Patent Application Publication
(10) Pub. No.: US 2022/0024046 A1
(43) Pub. Date: Jan. 27, 2022

(54) APPARATUS AND METHOD FOR DETERMINING INTERACTION BETWEEN HUMAN AND ROBOT

(71) Applicant: Electronics and Telecommunications Research Institute, Daejeon (KR)

(72) Inventors: Min-Su JANG, Daejeon (KR); Do-Hyung KIM, Daejeon (KR); Jae-Hong KIM, Daejeon (KR); Jae-Yeon LEE, Daejeon (KR)

(73) Assignee: Electronics and Telecommunications Research Institute, Daejeon (KR)

(21) Appl. No.: 17/082,843

(22) Filed: Oct. 28, 2020

(30) Foreign Application Priority Data
Jul. 24, 2020 (KR) 10-2020-0092240

(51) Int. Cl. B25J 11/00; B25J 13/08; B25J 9/16

(52) U.S. Cl. CPC B25J 11/0005; B25J 9/1697; B25J 9/1653; B25J 13/088

(57) ABSTRACT

Disclosed herein are an apparatus and method for determining a modality of interaction between a user and a robot. The apparatus includes memory in which at least one program is recorded and a processor for executing the program. The program may perform recognizing a user state and an environment state by sensing circumstances around a robot, determining an interaction capability state associated with interaction with a user based on the recognized user state and environment state, and determining the interaction behavior of the robot for the interaction with the user based on the user state, the environment state, and the interaction capability state.

### CROSS REFERENCE TO RELATED APPLICATION

This application claims the benefit of Korean Patent Application No. 10-2020-0092240, filed Jul. 24, 2020, which is hereby incorporated by reference in its entirety into this application.

### BACKGROUND OF THE INVENTION

### 1. Technical Field

The disclosed embodiment relates to technology for controlling interaction between a human and a robot living therewith.

### 2. Description of the Related Art

Various kinds of service robots are currently used to provide reception and information services in various stores, exhibition halls, airports, and the like. In welfare facilities for the aged and hospitals, robots are employed on a trial basis in order to care for residents and prevent dementia. Also, smart speakers and toy robots have been reported to have a positive effect on the health and emotional stability of the aged at home.

The most important function required of service robots that are being used in an environment in which the robots are frequently in contact with people is the capability to effectively interact with people. These robots may provide the service desired by people in a timely manner only when smooth interaction therebetween is possible.

The global service robot market is expected to grow to $100 billion by 2025, and when the time comes, every home will have a robot. Therefore, technology for enabling robots to successfully interact with people under various conditions is becoming more important.

As representative examples of a conventional method for interaction between a human and a robot, there are a method in which interaction is carried out by touching a screen at a close distance and a method in which interaction is carried out based on voice recognition and voice synthesis.

A touch screen enables a robot to intuitively provide comprehensive information using images and to easily receive the intention of a user through touch input. However, in this method, the user is able to receive information only when the user comes near to the robot and watches the screen. When the user is not viewing the robot or is not able to view the robot, it is difficult for the user to interact with the robot.

Interaction using voice may solve this problem. A robot is capable of delivering information using voice even when a user is not viewing the robot. However, information delivery in an aural manner may be unusable or erroneous when there is a lot of ambient noise or when the user is located far away from the robot. Furthermore, when audiovisual limitations are imposed by headphones, an eye patch, or the like worn by the user, the conventional methods become unable to provide effective interaction.

### DOCUMENTS OF RELATED ART

(Patent Document 1) Korean Patent Application Publication No. 10-2006-0131458

### SUMMARY OF THE INVENTION

An object of the disclosed embodiment is to raise the interaction success rate by recognizing a user activity context and determining and performing an interaction method suitable for the recognized context.

An apparatus for determining a modality of interaction between a user and a robot according to an embodiment may include memory in which at least one program is recorded and a processor for executing the program. The program may perform recognizing a user state and an environment state by sensing circumstances around the robot, determining an interaction capability state associated with interaction with the user based on the recognized user state and environment state, and determining the interaction behavior of the robot for the interaction with the user based on the user state, the environment state, and the interaction capability state.

Here, recognizing the user state and the environment state may be configured to sense the circumstances around the robot using a sensor including at least one of an omnidirectional microphone array, an RGB camera, and a depth camera.

Here, recognizing the user state and the environment state may be configured such that at least one of a noise level, a noise direction, at least one object, and the type of the at least one object is guessed as the environment state.

Here, recognizing the user state and the environment state may be configured such that, when at least one user is detected as the user state, at least one of the position of the at least one user, an object worn by the at least one user, the height of the face of the at least one user, features in the face of the at least one user, whether the eyes of the at least one user are open or closed, the gaze direction of the at least one user, a target on which attention of the at least one user is focused, and the posture of the at least one user is guessed.

Here, determining the interaction capability state may be configured to determine at least one of visual accessibility, indicating the degree of possibility that the user is able to pay visual attention to the robot, auditory accessibility, indicating the degree of possibility that the user is able to pay auditory attention to sound of the robot, and tactile accessibility, indicating the degree of possibility that the robot is able to come into contact with the user.

Here, the interaction capability state may be calculated as a numerical level.

Here, the interaction behavior may include at least one of sound output, screen output, a specific action, touching the user, and approaching the user.

Here, determining the interaction behavior may include determining the degree of availability of each type of interaction behavior to be ‘possible’, ‘limitedly possible’, or ‘impossible’ based on the user state, the environment state, and the interaction capability state and finally determining the interaction behavior based on the determined degree of availability of each type of interaction behavior.

Here, the program may further perform driving the robot so as to perform the determined interaction behavior and determining whether the interaction succeeds based on the performed interaction behavior. When it is determined that the interaction has not succeeded, the program may again perform recognizing the user state and the environment state by sensing the circumstances around the robot, determining the interaction capability state associated with the interaction with the user based on the recognized user state and environment state, and determining the interaction behavior of the robot for the interaction with the user based on the user state, the environment state, and the interaction capability state.

A method for determining a modality of interaction between a user and a robot according to an embodiment may include recognizing a user state and an environment state by sensing circumstances around the robot, determining an interaction capability state associated with interaction with the user based on the recognized user state and environment state, and determining the interaction behavior of the robot for the interaction with the user based on the user state, the environment state, and the interaction capability state.

Here, recognizing the user state and the environment state may be configured to sense the circumstances around the robot using a sensor including at least one of an omnidirectional microphone array, an RGB camera, and a depth camera.

Here, recognizing the user state and the environment state may be configured such that at least one of a noise level, a noise direction, at least one object, and the type of the at least one object is guessed as the environment state.

Here, recognizing the user state and the environment state may be configured such that, when at least one user is detected as the user state, at least one of the position of the at least one user, an object worn by the at least one user, the height of the face of the at least one user, features in the face of the at least one user, whether the eyes of the at least one user are open or closed, the gaze direction of the at least one user, a target on which attention of the at least one user is focused, and the posture of the at least one user is guessed.

Here, determining the interaction capability state may be configured to determine at least one of visual accessibility, indicating the degree of possibility that the user is able to pay visual attention to the robot, auditory accessibility, indicating the degree of possibility that the user is able to pay auditory attention to sound of the robot, and tactile accessibility, indicating the degree of possibility that the robot is able to come into contact with the user.

Here, the interaction capability state may be calculated as a numerical level.

Here, the interaction behavior may include at least one of sound output, screen output, a specific action, touching the user, and approaching the user.

Here, determining the interaction behavior may include determining the degree of availability of each type of interaction behavior to be ‘possible’, ‘limitedly possible’, or ‘impossible’ based on the user state, the environment state, and the interaction capability state and finally determining the interaction behavior based on the determined degree of availability of each type of interaction behavior.

Here, the method may further include driving the robot so as to perform the determined interaction behavior and determining whether interaction succeeds based on the performed interaction behavior. When it is determined that the interaction has not succeeded, recognizing the user state and the environment state by sensing the circumstances around the robot, determining the interaction capability state associated with the interaction with the user based on the recognized user state and environment state, and determining the interaction behavior of the robot for the interaction with the user based on the user state, the environment state, and the interaction capability state may be performed again.

A method for determining a modality of interaction between a user and a robot according to an embodiment may include recognizing a user state and an environment state by sensing circumstances around the robot, determining, based on the recognized user state and environment state, at least one of visual accessibility, indicating the degree of possibility that the user is able to pay visual attention to the robot, auditory accessibility, indicating the degree of possibility that the user is able to pay auditory attention to sound of the robot, and tactile accessibility, indicating the degree of possibility that the robot is able to come into contact with the user, and determining the interaction behavior of the robot for interaction with the user based on at least one of the visual accessibility, the auditory accessibility, and the tactile accessibility.

Here, determining the interaction behavior may include determining the degree of availability of each type of interaction behavior, including at least one of voice output, screen output, a specific action, touching the user, and approaching the user, to be ‘possible’, ‘limitedly possible’, or ‘impossible’ and finally determining the interaction behavior based on the determined degree of availability of each type of interaction behavior.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a schematic block diagram of an apparatus for determining a modality of interaction between a user and a robot according to an embodiment;

FIG. 2 is a flowchart of a method for determining a modality of interaction between a user and a robot according to an embodiment;

FIG. 3 is an exemplary view for explaining the determination of a viewing angle according to an embodiment;

FIG. 4 is an exemplary view for explaining the determination of a viewing angle according to an embodiment;

FIG. 5 is a flowchart for explaining the step of determining visual accessibility according to an embodiment;

FIG. 6 is a flowchart for explaining the step of determining auditory accessibility according to an embodiment;

FIG. 7 is a flowchart for explaining the step of determining tactile accessibility according to an embodiment; and

FIG. 8 is a view illustrating a computer system configuration according to an embodiment.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

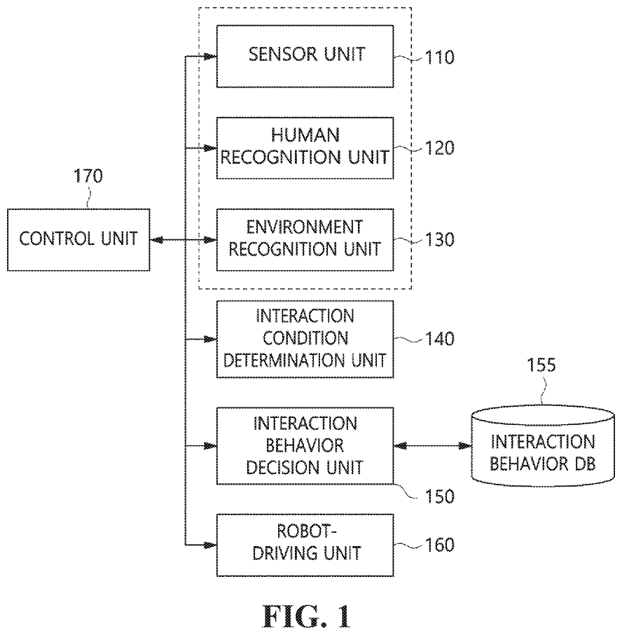

Hereinafter, an apparatus and method according to an embodiment will be described in detail with reference to FIGS. 1 to 8.

FIG. 1 is a schematic block diagram of an apparatus for determining a modality of interaction between a user and a robot according to an embodiment.

Referring to FIG. 1, an apparatus 100 for determining a modality of interaction between a user and a robot (referred to as an ‘apparatus’ hereinbelow) may include a sensor unit 110, a human recognition unit 120, an environment recognition unit 130, an interaction condition determination unit 140, an interaction behavior decision unit 150, a robot-driving unit 160, and a control unit 170. Additionally, the apparatus 100 may further include an interaction behavior DB 155.

The sensor unit 110 includes various types of sensor devices required for recognizing the structure and state of a space around a robot and a user and objects located in the space, and delivers sensing data to the control unit 170.

Here, the sensor unit 110 includes at least one of an omnidirectional microphone array, an RGB camera, and a depth camera.

Here, the omnidirectional microphone array may be used to estimate the intensity and direction of sound generated in an environment.

Here, the RGB camera may be used to detect objects and a user in the scene of a surrounding environment and to recognize the locations, postures, and behavior thereof.

Here, the depth camera may be used to detect the direction of the object or user based on the location of the robot and the distance from the robot to the object or the user.

The human recognition unit 120 detects a user and recognizes the activity context of the user using sensor data. That is, the human recognition unit 120 detects a routine activity that the user is currently doing, an object on which the attention of the user is focused, and a device used or worn by the user, and delivers the result to the control unit 170.

The environment recognition unit 130 recognizes the environmental situation using sensor data. According to an embodiment, the environment recognition unit 130 determines the noise level in the environment and delivers the result to the control unit 170.

The interaction condition determination unit 140 recognizes the activity context of a user and an environmental state, thereby determining whether the user and the robot are able to interact with each other.

The interaction behavior decision unit 150 decides on the interaction behavior of a robot depending on the result of the determination of the interaction condition. That is, the interaction behavior decision unit 150 decides on suitable interaction behavior of the robot by integratedly analyzing the user recognition result and the environmental state recognition result respectively received from the human recognition unit 120 and the environment recognition unit 130, and delivers the result to the control unit 170. For example, when ambient noise is above a certain level and when the user is looking in the opposite direction relative to the robot, the robot may attempt to interact with the user after drawing the attention of the user by moving to a point on the line of sight of the user. If the robot is capable only of adjusting the orientation of the body thereof without the function of moving the body thereof, the robot may attempt to interact with the user by turning the body thereof to the direction of the user and increasing an output volume.

According to an embodiment, the interaction behavior DB 155 may store a table in which the degree of possibility of interaction behavior including at least one of voice output, screen output, a specific action, touching a person, and approaching a person is classified as ‘possible’, ‘limitedly possible’, or ‘impossible’ depending on the respective levels of visual accessibility, auditory accessibility, and tactile accessibility. That is, the interaction behavior DB 155 may store a table configured as shown in Table 4, which will be described later.

The interaction behavior decision unit 150 may finally determine the interaction behavior based on the data stored in the table in the interaction behavior DB 155.

The robot-driving unit 160 includes devices for physical and electronic control of the robot and performs the function of controlling these devices in response to an instruction from the control unit 170. For example, the robot-driving unit 170 includes robot control functions, such as receiving a spoken sentence and playing the same through a. speaker, moving an arm attached to the robot, adjusting the orientation of the body of the robot, moving the robot to a specific location in a space, and the like.

The control unit 170 controls the interaction between the components of the apparatus and execution of the functions of the components.

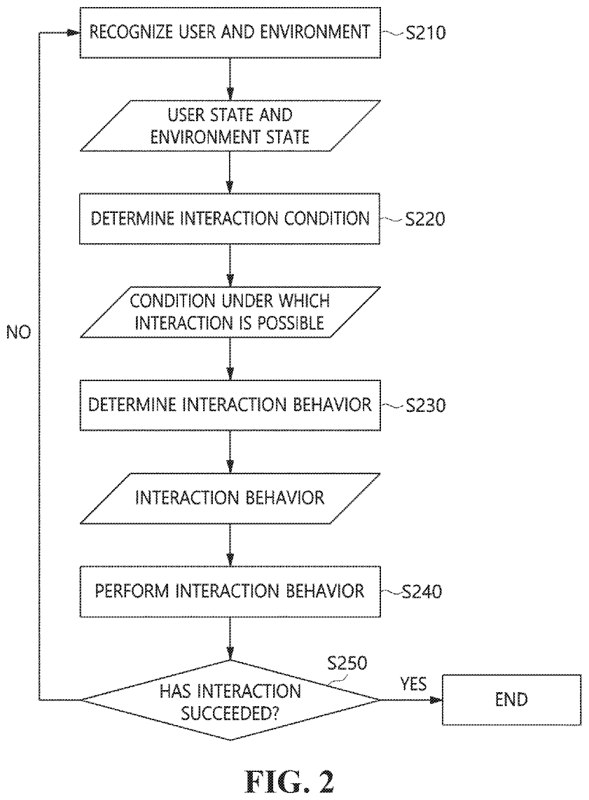

FIG. 2 is a flowchart of a method for determining a modality of interaction between a user and a robot according to an embodiment.

Referring to FIG. 2, the method for determining a modality of interaction between a user and a robot may include recognizing a user state and an environment state by sensing circumstances around a robot at step S210, determining an interaction capability state associated with interaction with a user based on the recognized user state and environment state at step S220, and determining the interaction behavior of the robot for the interaction with the user based on the user state, the environment state, and the interaction capability state at step S230.

Additionally, the method for determining a modality of interaction between a user and a robot may further include driving the robot so as to perform the determined interaction behavior at step S240.

Also, the method for determining a modality of interaction between a user and a robot may further include determining whether the interaction succeeds at step S250 after driving the robot so as to perform the interaction behavior at step S240.

When it is determined at step S250 that the interaction has not succeeded, steps S210 to S240 may be repeatedly performed.

Here, at the step (S210) of recognizing the user state and the environment state by sensing the circumstances around the robot, the apparatus 100 collects sensing data, which is required in order to determine the state of the user around the robot and the environment state, using at least one of an omnidirectional microphone array, an RGB camera, and a depth camera, and recognizes the user state and the environment state based on the collected sensing data.

Here, at the step (S210) of recognizing the user state and the environment state by sensing the circumstances around the robot, at least one of a noise level, a noise direction, at least one object, and the type of the at least one object may be estimated as the environment state.

That is, the apparatus 100 analyzes ambient sound data acquired using the omnidirectional microphone array, thereby estimating the intensity of noise generated in the vicinity of the robot and the location at which the noise is generated.

Also, the apparatus 100 detects the type and location of an object in an image acquired using the RGB camera. Here, the apparatus 100 may additionally estimate the distance from the robot to the detected object and the direction of the detected object based on the robot using a depth image acquired using the depth camera.

Here, the environment state estimated as described above may be stored and managed using the data structure shown in the following Table 1.

TABLE 1

| properly | value | |
|---|---|---|
| noise level | 50 | dB |
| noise direction | 60 | degrees |

| | |
|---|---|
| object list | {object ID: OBJ001, type: TV, direction: 80 degrees, |
| | distance: 5 m}{object ID: OBJ002, type: fridge, |
| | direction: 130 degrees, distance: 2 m} . . . |

Meanwhile, at the step (S210) of recognizing the user state and the environment state by sensing the circumstances around the robot, at least one user is detected as the user state, and at least one of the location of the user, the height of the face of the user, features in the face of the user, an object worn by the user, whether eyes of the user are open or closed, the gaze direction of the user, a target on which the attention of the user is focused, and the posture of the user may be estimated.

That is, the apparatus 100 detects a user in the image acquired using the RGB camera and traces the user over time. Here, the user may be a single user or two or more users.

Also, in order to estimate the location of the user, the apparatus 100 estimates the direction of the detected user based on the location of the robot and estimates the distance from the robot to the detected user using a depth image acquired using the depth camera.

Here, in order to detect the height of the face of the user, the apparatus 100 detects the location of the face of the user in the image acquired using the RGB camera, thereby estimating the height of the face.

Here, in order to detect features in the face of the user, the apparatus 100 detects the locations of feature points representing eyes. eyebrows, a nose, a mouth, and a jaw line in the face detected in the image acquired using the RGB camera.

Here, in order to guess an object worn by the user, the apparatus 100 detects an object interfering with the interaction with the robot by being worn on the face detected in the image acquired using the RGB camera. For example, in the image acquired using the RGB camera, whether an eye patch is present is detected based on the locations of feature points corresponding to the eyes, or whether earphones, headphones or the like are present is detected based on the locations of feature points corresponding to the ears, and the like. That is, an eye patch, earphones, headphones, and the like are objects that can interfere with the interaction with the robot by covering eyes or ears.

Here, in order to guess whether the user is focusing on something, the apparatus 100 may guess whether the eyes or mouth of the user are open. That is, in the image acquired using the RGB camera, whether the eyes of the user are open may be determined based on the locations of the feature points corresponding to the eyes, and whether the mouth of the user is open may be determined based on the location of the feature point corresponding to the mouth.

Here, in order to estimate the gaze direction of the user, the apparatus 100 may detect the locations of the feature points corresponding to the eyes in the face detected in the image acquired using the RGB camera, and may recognize the orientation of the face based on the locations of the eyes.

Here, in order to guess the target on which the attention of the user is focused, the apparatus 100 may guess the target on which the attention of the user is focused by synthesizing the result of estimating the location of the user, the orientation of the face of the user, the location of an object in the environment, and the type of the object. That is, the apparatus 100 may guess an object falling within a field of view that is set based on the location of the user and the orientation of the face of the user as the target on which the attention of the user is focused.

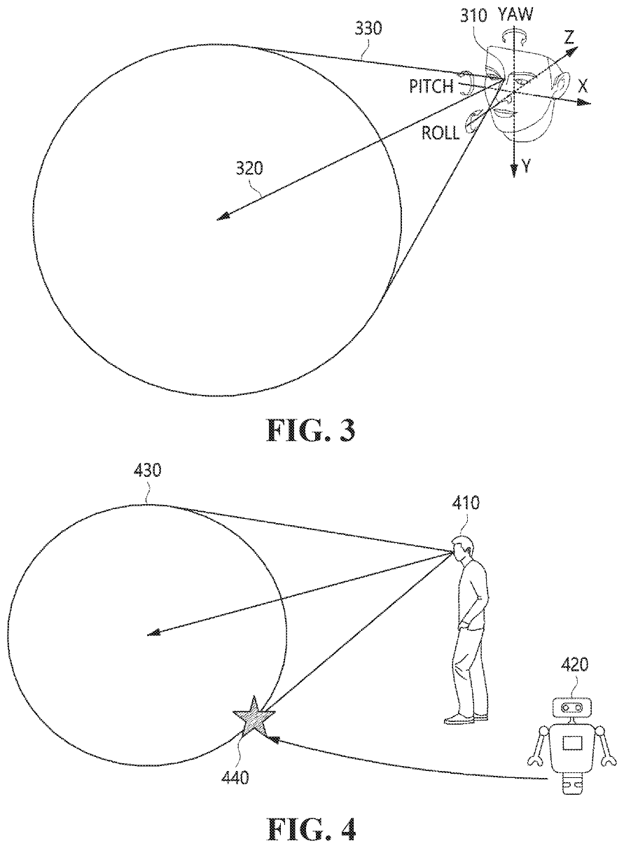

FIG. 3 is an exemplary view for explaining the determination of a viewing angle according to an embodiment.

Referring to FIG. 3, a human's binocular field of view may be over 120 degrees from top to bottom and side to side. Therefore, the field of view may be geometrically calculated based on 120 degrees.

For example, a cone having a center point 310 between the two eyes of a person as the apex thereof and having a line 320 extending in a frontward direction from the center point 310 as the axis thereof may be formed such that the generatrix of the cone makes an angle of 60 degrees to the axis of the cone. That is, the angle between the line 320 and the line 330 may be 60 degrees. Here, the volume of the cone may correspond to the field of view of the person.

Therefore, the person may recognize an object falling within the volume of the cone or an object lying on the edge of the cone. Here, because the field of view of a human may vary depending on the situation or according to a theory, the present invention is not limited to the above description.

Meanwhile, in order to estimate the posture of the user, the apparatus 100 detects the positions of the joints of the user in the image acquired using the RGB camera, thereby estimating the posture, such as sitting, standing, or the like, based on the detected positions of the joints.

Here, the user state guessed as described above may be stored and managed using the data structure shown in the following Table 2.

TABLE 2

| person | property | value |
|---|---|---|
| U001 | location | {direction: 80 degrees, distance: 5 m} |
| | worn object | earphones |
| | face | {height: 1.6 m, full-face: no} |
| | are eyes closed | no |
| | gaze direction | {height: 1.6 m, yaw: 60 degrees, |
| | | pitch: −45 degrees} |
| | focused target | OBJ001 |
| | posture | sitting |
| U002 | . . . | . . . |

Meanwhile, at the step (S220) of determining the interaction capability state associated with the interaction with the user based on the recognized user state and environment state illustrated in FIG. 2, at least one of visual accessibility, indicating the degree of possibility that the user is able to pay visual attention to the robot, auditory accessibility, indicating the degree of possibility that the user is able to pay auditory attention to the sound of the robot, and tactile accessibility, indicating the degree of possibility that the robot is able to come into contact with the user may be determined as the interaction capability state.

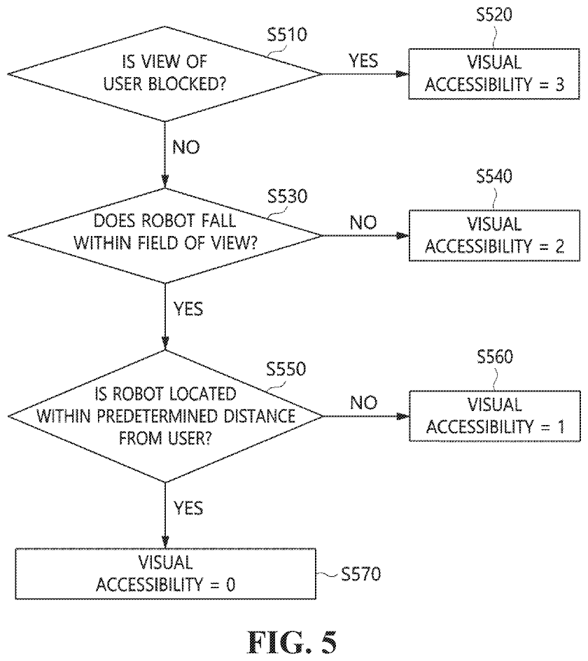

Here, each of the visual accessibility, the auditory accessibility, and the tactile accessibility may be calculated as a numerical level. Calculating the numerical level will be described in detail later with reference to FIGS. 5 to 7.

Here, the interaction capability state determined as described above may be stored and managed using the data structure shown in the following Table 3.

TABLE 3

| user ID | property | value |
|---|---|---|
| U001 | visual accessibility | 1 |
| | auditory accessibility | 0 |
| | tactile accessibility | 0 |
| U002 | | . . . |

Meanwhile, at the step (S230) of determining the interaction behavior of the robot for interaction with the user based on the user state, the environment state, and the interaction capability state, which is illustrated in FIG. 2, the interaction behavior may include at least one of voice output, screen output, an action, a touch, and movement.

Here, the apparatus 100 may set ‘impossible’, ‘possible’, or ‘limitedly possible’ as the degree of availability of each type of interaction behavior.

Here, the degree of availability of interaction based on the numerical level of the interaction capability state, that is, the numerical levels of visual accessibility, auditory accessibility, and tactile accessibility according to an embodiment, may be illustrated as shown in the following Table 4.

TABLE 4

| interaction availability | | | | | | | |
|---|---|---|---|---|---|---|---|
| visual | auditory | tactile | interaction behavior | | | | |
| accessibility | accessibility | accessibility | voice | screen | action | touch | movement |
| 0 | 0 | 0, 1 | possible | possible | simple | not | no |
| | | | | | interaction | considered | movement |
| | | | | | possible | | |
| 0 | 1 | 0, 1 | limitedly | possible | simple | not | no |
| | | | possible | | interaction | considered | movement |
| | | | | | possible | | |
| 0 | 2 | 0, 1 | impossible | possible | simple | not | no |
| | | | | | interaction | considered | movement |
| | | | | | possible | | |
| 1 | 0 | 0, 1 | possible | simple | simple | impossible | approach |
| | | | | interaction | interaction | | user |
| | | | | possible | possible | | |
| 1 | 1 | 1 | limitedly | simple | simple | impossible | approach |
| | | | possible | interaction | interaction | | user |
| | | | | possible | possible | | |
| 1 | 2 | 1 | impossible | simple | simple | impossible | approach |
| | | | | interaction | interaction | | user |
| | | | | possible | possible | | |
| 2 | 0 | 0 | possible | impossible | impossible | possible | move into |
| | | | | | | | user's field |
| | | | | | | | of view |
| 2 | 1 | 0 | limitedly | impossible | impossible | possible | move into |
| | | | possible | | | | user's field |
| | | | | | | | of view |
| 2 | 2 | 0 | impossible | impossible | impossible | possible | move into |
| | | | | | | | user's field |
| | | | | | | | of view |
| 2 | 0 | 1 | possible | impossible | impossible | impossible | move into |
| | | | | | | | user's field |
| | | | | | | | of view |
| 2 | 1 | 1 | limitedly | impossible | impossible | impossible | move into |
| | | | possible | | | | user's field |
| | | | | | | | of view |
| 2 | 2 | 1 | impossible | impossible | impossible | impossible | move into |
| | | | | | | | user's field |
| | | | | | | | of view |
| 3 | 0 | 0 | possible | impossible | impossible | possible | no |
| | | | | | | | movement |
| 3 | 1 | 0 | limitedly | impossible | impossible | possible | no |
| | | | possible | | | | movement |
| 3 | 2 | 0 | impossible | impossible | impossible | possible | no |
| | | | | | | | movement |
| 3 | 0 | 1 | possible | impossible | impossible | impossible | approach |
| | | | | | | | user |
| 3 | 1 | 1 | limitedly | impossible | impossible | impossible | approach |
| | | | possible | | | | user |
| 3 | 2 | 1 | impossible | impossible | impossible | impossible | approach |
| | | | | | | | user |

Referring to Table 4, ‘voice’, among the types of interaction behavior, indicates the behavior of enabling conversation between the robot and the user, and may be determined based on the level of auditory accessibility.

Here, ‘possible’ indicates the state in which voice-based interaction is possible such that the robot is capable of talking with the user.

Here, ‘limitedly possible’ indicates the state in which interaction using short phrases, such as a brief greeting, a request to pay attention, or the like, is possible, and interaction may be attempted after the volume is turned up within the extent possible to at home if necessary. Here, when the interaction capability state is changed as the result of performing the limited voice interaction, interaction behavior suitable for the changed state may be selected again.

Referring to Table 4. ‘screen’, among the types of interaction behavior, indicates that the robot displays information intended to be transmitted to the user using a display means installed therein, and may be determined based on the level of visual accessibility.

Here, ‘possible’ indicates the state in which information intended to be delivered can be delivered to the user by displaying all of the information on the screen.

Here. ‘simple interaction possible’ indicates the state in which simple information, such as a greeting, a request to pay attention, or the like, may be provided by displaying a large image or video on the screen.

Referring to Table 4, ‘action’, among the types of interaction behavior, may be a greeting using a part capable of being driven for communication, such as a robot arm or the like, and may be determined based on the level of visual accessibility.

Here, ‘simple interaction possible’ and ‘impossible’ may be included in order to represent the degree of availability of interaction behavior corresponding to ‘action’. That is, because ‘action’ is not adequate to be used to convey a complicated meaning or for continuous interaction due to the properties thereof, ‘possible’, indicating that continuous interaction is possible, cannot be included as the degree of availability.

Here, ‘simple interaction possible’ may be the state in which the robot is capable of attempting simple and short interaction such as a greeting, a request to pay attention, and the like when a part capable of being driven for communication, such as an arm or the like, is installed in the robot and when the robot falls within the field of view of the user.

Referring to Table 4, ‘touch’, among the types of interaction behavior, indicates that the robot touches the body of the user with the arm or the like thereof, and may be determined based on the level of tactile accessibility.

Here, ‘possible’ may be the state in which the robot is capable of coming into slight contact with the body of the user using the arm thereof in order to make the user aware of the presence of the robot and to indicate a request to pay attention.

Here, ‘impossible’ may be the state in which the robot is not capable of coming into contact with the user due to the distance therebetween, or some other reason.

Referring to Table 4, ‘movement’, among the types of interaction behavior, indicates that the robot moves towards the user, and may be determined based on the levels of visual and tactile accessibility.

Here, ‘approach user’ is performed in order to decrease the distance between the user and the robot such that the condition under which interaction behavior that can be selected is not present or is limited is changed to the condition wider which interaction behavior is limitedly possible or possible.

Also, ‘approach user’ may be performed after a simple interaction for requesting the user to pay attention is attempted or simultaneously with such an attempt, whereby the attention of the user may be quickly and successfully drawn. For example, when the user is looking in the direction of the robot but the distance therebetween is 5 m or longer (a visible condition 1) and when there is noise because a TV is turned on (an audible condition 1), the robot expresses the fact that interaction is needed by showing an eye-catching image on the screen while approaching the user, thereby raising the interaction success rate.

Here, ‘move into user's field of view’ is movement for moving into the field of view of the user when the robot is out of the field of view. To this end, the 3D position of the face of the user present in the space detected or estimated at step S210, the orientation of the face of the user, and the locations of the two eves of the user may be used as described above.

FIG. 4 is an exemplary view for explaining the determination of a viewing angle according to an embodiment.

Referring to FIG. 4, a robot 420 sets the coordinates of any point on the edge 430 of the cone-shaped area, which is capable of arriving through a shortest path, as a target point 440 and moves to the target point 440, thereby moving into the field of view of a user 410.

Here, when it is impossible for the robot to move into the field of view because the orientation of the face of the user continuously changes or because the user is looking overhead, the whole body posture information may be used.

For example, after the forward direction in which the upper body of the user is facing is identified by drawing a line perpendicular to the straight line connecting the joints of both shoulders of the user, a point in the forward direction that is 1 to 1.5 m distant from the user is set as the target point, and the robot moves to the target point, whereby the robot may move into the field of view of the user. Here, 1 to 1.5 m corresponds to a social distance of humans.

Until the state of voice or a screen, which is the main medium of information delivery, is changed to a ‘possible’ state, ‘limitedly possible’ behavior or movement is continuously performed. When voice and screen interaction simultaneously become available, a suitable means is selected and used depending on the purpose of the interaction, whereby the interaction is performed.

FIG. 5 is a flowchart for explaining the step of determining visual accessibility according to an embodiment.

Referring to FIG. 5, the apparatus 100 determines whether it is impossible to draw the visual attention of the user at step S510.

When it is determined at step S510 that it impossible to draw the visual attention, the apparatus 100 sets a visual accessibility level to ‘3’ at step S520. For example, when the user is sitting on a massage chair while wearing an eye patch or when the user is dozing with the eyes closed, the robot is not capable of drawing the visual attention of the user.

Conversely, when it is determined at step S510 that it is possible to draw the visual attention, the apparatus 100 determines whether the robot falls within the field of view of the user at step S530.

When it is determined at step S530 that the robot is out of the field of view of the user, the apparatus 100 sets the visual accessibility level to ‘2’ at step S540. This is the state in which the robot is out of the field of view of the user, and may be, for example, the state in which the user is watching TV with the robot behind the user or in which the user is cleaning the house or washing the dishes at a long distance from the robot.

When it is determined at step S530 that the robot falls within the field of view of the user, the apparatus 100 determines whether the robot is located within a predetermined distance from the user at step S550.

When it is determined at step S550 that the robot is not present within the predetermined distance from the user, the apparatus 100 sets the visual accessibility level to ‘1’ at step S560. That is, this indicates the state in which, although the robot falls within the field of view of the user, it is difficult for the robot to provide information to the user because of the long distance from the user.

When it is determined at step S550 that the robot is present within a predetermined distance from the user, the apparatus 100 sets the visual accessibility level to ‘0’ at step S570. This indicates the state in which the robot is capable of immediately drawing the attention of the user because the robot falls within the field of view of the user while being located close to the user.

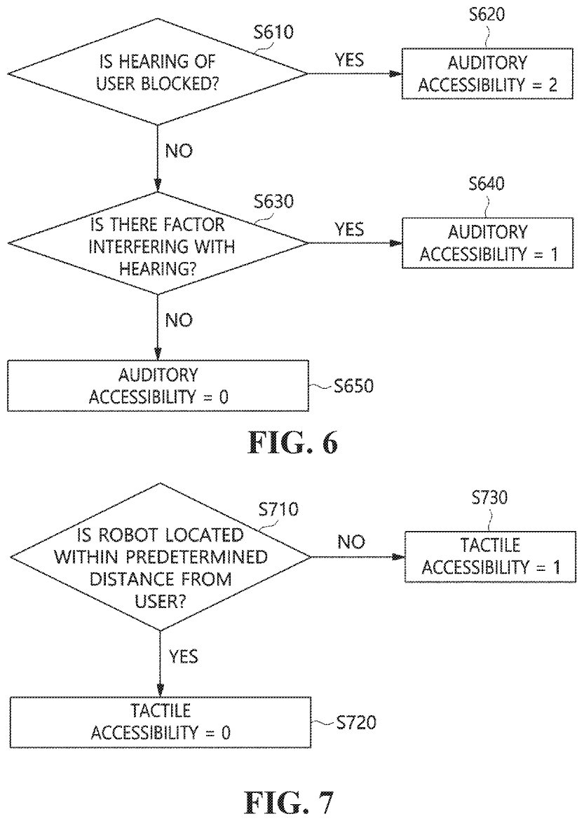

FIG. 6 is a flowchart for explaining the step of determining auditory accessibility according to an embodiment.

Referring to FIG. 6, the apparatus 100 determines whether the hearing of the user is blocked at step S610.

When it is determined at step S610 that the hearing of the user is blocked, the apparatus 100 sets an auditory accessibility level to ‘2’ at step S620. This indicates the state in which the user is not able to hear the sound made by the robot. For example, this may be the state in which the user wears earphones or headphones.

Conversely, when it is determined at step S610 that the hearing of the user is not blocked, the apparatus 100 determines whether there is a factor interfering with hearing at step S630.

When it is determined at step S630 that there is a factor interfering with the hearing of the user, the apparatus 100 sets the auditory accessibility level to ‘1’ at step S640. That is, this indicates the state in which it is difficult for the user to hear sound made by the robot because the user is attentively listening to something or because there is something interfering with sound made by the robot. For example, this may be the state in which the user is watching TV or in which there is ambient noise and the robot is distant from the user.

Conversely, when it is determined at step S630 that there is no factor interfering with hearing of the user, the apparatus 100 sets the auditory accessibility level to ‘0’ at step S650. This indicates the state in which the user easily hears sound made by the robot. That is, this may be the state in which there is little ambient noise, so it is easy for the user to hear the sound of the robot.

FIG. 7 is a flowchart for explaining the step of determining tactile accessibility according to an embodiment.

Referring to FIG. 7, the apparatus 100 determines whether the robot is capable of coming into contact with the user at step S710.

When it is determined at step S710 that the robot is not capable of coming into contact with the user, the apparatus 100 sets a tactile accessibility level to ‘1’ at step S730. This indicates the state in which the robot is not capable of drawing the attention of the user by touching the user. This may be the state in which the robot does not have a part capable of being driven, such as an arm or the like, or in which the robot is distant from the user.

Conversely, when it is determined at step S710 that the robot is capable of coming into contact with the user, the apparatus 100 sets the tactile accessibility level to ‘0’ at step S720. This indicates the state in which the robot is capable of drawing the attention of the user by touching the user. For example, this may be the state in which the robot has a part capable of being driven, such as an arm or the like, and in which the robot is located close enough to reach the user.

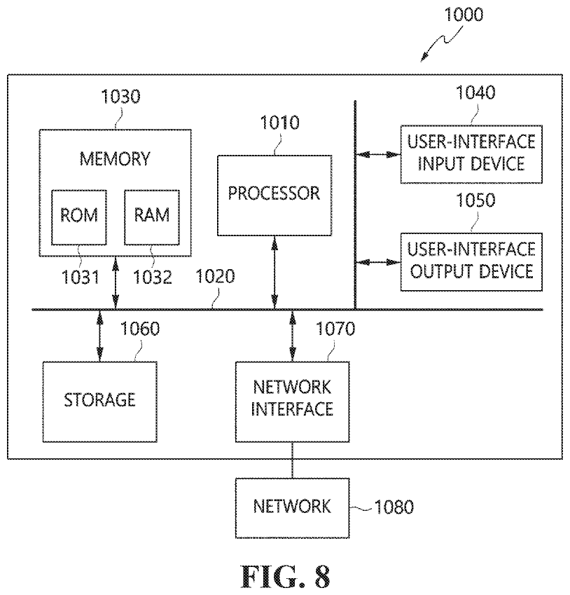

FIG. 8 is a view illustrating a computer system configuration according to an embodiment.

The apparatus for determining a modality of interaction between a user and a robot according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, and an information delivery medium. For example, the memory 1030 may include ROM 1031 or RAM 1032.

According to an embodiment, a user activity context is recognized and an interaction method suitable for the recognized context is determined and performed, whereby the interaction success rate may be improved.

That is, because a robot living with a user is capable of communicating with the user through an accessible method suitable for the current activity of the user, the user is able to more easily and successfully acquire information provided by the robot, whereby the efficiency of service provided by the robot may be improved.

Although the embodiments of the present invention have been described with reference to the accompanying drawings, those skilled in the art will appreciate that the present invention may be practiced in other specific forms without changing the technical spirit or essential features of the present invention. Therefore, the embodiments described above are illustrative in all aspects and should not be understood as limiting the present invention.

What is claimed is:

1. An apparatus for determining a modality of interaction between a user and a robot, comprising:
memory in which at least one program is recorded; and
a processor for executing the program,
wherein the program performs
recognizing a user state and an environment state by sensing circumstances around the robot;
determining an interaction capability state associated with interaction with the user based on the recognized user state and environment state; and
determining an interaction behavior of the robot for the interaction with the user based on the user state, the environment state, and the interaction capability state.

2. The apparatus of claim 1, wherein recognizing the user state and the environment state is configured to sense the circumstances around the robot using a sensor including at least one of an omnidirectional microphone array, an RGB camera, and a depth camera.

3. The apparatus of claim 1, wherein recognizing the user state and the environment state is configured such that at least one of a noise level, a noise direction, at least one object, and a type of the at least one object is guessed as the environment state.

4. The apparatus of claim 3, wherein recognizing the user state and the environment state is configured such that, when at least one user is detected as the user state, at least one of a position of the at least one user, an object worn by the at least one user, a height of a face of the at least one user, features in the face of the at least one user, whether eyes of the at least one user are open or closed, a gaze direction of the at least one user, a target on which attention of the at least one user is focused, and a posture of the at least one user is guessed.

5. The apparatus of claim 4, wherein determining the interaction capability state is configured to determine at least one of visual accessibility indicating a degree of possibility that the user is able to pay visual attention to the robot, auditory accessibility indicating a degree of possibility that the user is able to pay auditory attention to sound of the robot, and tactile accessibility indicating a degree of possibility that the robot is able to come into contact with the user.

6. The apparatus of claim 5, wherein the interaction capability state is calculated as a numerical level.

7. The apparatus of claim 1, wherein the interaction behavior includes at least one of sound output, screen output, a specific action, touching the user, and approaching the user.

8. The apparatus of claim 7, wherein determining the interaction behavior comprises:
determining a degree of availability of each type of interaction behavior to be ‘possible’, ‘limitedly possible’, or ‘impossible’ based on the user state, the environment state, and the interaction capability state; and
finally determining the interaction behavior based on the determined degree of availability of each type of interaction behavior.

9. The apparatus of claim 1, wherein:
the program further performs
driving the robot so as to perform the determined interaction behavior and
determining whether the interaction succeeds based on the performed interaction behavior, and
when it is determined that the interaction has not succeeded, the program again performs recognizing the user state and the environment state by sensing the circumstances around the robot, determining the interaction capability state associated with the interaction with the user based on the recognized user state and environment state, and determining the interaction behavior of the robot for the interaction with the user based on the user state, the environment state, and the interaction capability state.

10. A method for determining a modality of interaction between a user and a robot, comprising:
recognizing a user state and an environment state by sensing circumstances around the robot;
determining an interaction capability state associated with interaction with user based on the recognized user state and environment state; and
determining interaction behavior of the robot for the interaction with the user based on the user state, the environment state, and the interaction capability state.

11. The method of claim 10, wherein recognizing the user state and the environment state is configured to sense the circumstances around the robot using a sensor including at least one of an omnidirectional microphone array, an RGB camera, and a depth camera.

12. The method of claim 10, wherein recognizing the user state and the environment state is configured such that at least one of a noise level, a noise direction, at least one object, and a type of the at least one object is guessed as the environment state.

13. The method of claim 12, wherein recognizing the user state and the environment state is configured such that, when at least one user is detected as the user state, at least one of a position of the at least one user, an object worn by the at least one user, a height of a face of the at least one user, features in the face of the at least one user, whether eves of the at least one user are open or closed, a gaze direction of the at least one user, a target on which attention of the at least one user is focused, and a posture of the at least one user is guessed.

14. The method of claim 13, wherein determining the interaction capability state is configured to determine at least one of visual accessibility indicating a degree of possibility that the user is able to pay visual attention to the robot, auditory accessibility indicating a degree of possibility that the user is able to pay auditory attention to sound of the robot, and tactile accessibility indicating a degree of possibility that the robot is able to come into contact with the user.

15. The method of claim 14, wherein the interaction capability state is calculated as a numerical level.

16. The method of claim 14, wherein the interaction behavior includes at least one of sound output, screen output, a specific action, touching the user, and approaching the user.

17. The method of claim 16, wherein determining the interaction behavior comprises:
determining a degree of availability of each type of interaction behavior to be ‘possible’, ‘limitedly possible’, or ‘impossible’ based on the user state, the environment state, and the interaction capability state; and
finally determining the interaction behavior based on the determined degree of availability of each type of interaction behavior.

18. The method of claim 10, further comprising:
driving the robot so as to perform the determined interaction behavior; and
determining whether interaction succeeds based on the performed interaction behavior,
wherein:
when it is determined that the interaction has not succeeded, recognizing the user state and the environment state by sensing the circumstances around the robot, determining the interaction capability state associated with the interaction with the user based on the recognized user state and environment state, and determining the interaction behavior of the robot for the interaction with the user based on the user state, the environment state, and the interaction capability state are performed again.

19. A method for determining a modality of interaction between a user and a robot, comprising:
recognizing a user state and an environment state by sensing circumstances around the robot;
determining, based on the recognized user state and environment state, at least one of visual accessibility indicating a degree of possibility that the user is able to pay visual attention to the robot, auditory accessibility indicating a degree of possibility that the user is able to pay auditory attention to sound of the robot, and tactile accessibility indicating a degree of possibility that the robot is able to come into contact with the user; and
determining an interaction behavior of the robot for interaction with the user based on at least one of the visual accessibility, the auditory accessibility, and the tactile accessibility.

20. The method of claim 9, wherein determining the interaction behavior comprises:
determining a degree of availability of each type of interaction behavior, including at least one of voice output, screen output, a specific action, touching the user, and approaching the user, to be ‘possible’, ‘limitedly possible’, or ‘impossible’; and
finally determining the interaction behavior based on the determined degree of availability of each type of interaction behavior.
